(19) United States
(12) Patent Application Publication
(10) Pub. No.: US 2026/0048329 A1
(43) Pub. Date: Feb. 19, 2026

(54) SYSTEM AND METHOD FOR GENERATING AND DELIVERING INTERACTIVE AI-DRIVEN TEXT-BASED GAME NARRATIVES VIA SMS/MMS

(71) Applicant: Jonathan Micah Cooper, Baltimore, MD (US)

(72) Inventor: Jonathan Micah Cooper, Baltimore, MD (US)

(21) Appl. No.: 18/804,813

(22) Filed: Aug. 14, 2024

(51) Int. Cl. A63F 13/80; A63F 13/332; A63F 13/35; A63F 13/75; A63F 13/77

(52) U.S. Cl. CPC A63F 13/80; A63F 13/332; A63F 13/35; A63F 13/75; A63F 13/77; A63F 2300/537

(57) ABSTRACT

A system and method are disclosed for providing an interactive, AI-driven, text-based game via SMS and MMS. The system comprises an SMS Gateway, a Game Server, a Database, and a Generative AI model. The method involves receiving player inputs via SMS, dynamically generating game narratives using AI, and delivering these narratives back to the player via SMS/MMS, providing an engaging and accessible gaming experience on all types of mobile devices.

### FEDERALLY SPONSORED RESEARCH AND DEVELOPMENT

No federally sponsored research or development was involved in the creation of this invention.

### PRIOR ART

Interactive text-based games have been a cornerstone of digital entertainment, offering immersive narrative experiences shaped by player choices. Traditionally, these games rely on predefined narrative paths, where player decisions lead to fixed outcomes. While this approach enables some degree of interactivity, it inherently limits the variability and personalization of the gameplay experience.

Currently available systems, such as AdventureGames.ai and AI-Quest, are predominantly browser-based or require the installation of mobile applications. These platforms leverage advanced AI techniques to create interactive narratives, but they necessitate an internet connection and are designed for use on advanced mobile devices. These systems, while effective in certain contexts, are not universally accessible. Users with basic mobile phones or those in regions with limited or unreliable internet connectivity may find it challenging to engage with these systems. Furthermore, these systems typically do not fully exploit the potential of SMS technology to deliver interactive content, which could be accessible to a broader audience regardless of their device capabilities.

In addition to these products, prior art such as U.S. Pat. No. 7,788,176B2, titled “System and method for providing online SMS games,” discloses a method for providing SMS-based games to any SMS-equipped device without requiring additional applications. However, this system primarily focuses on delivering a list of predefined SMS games and does not employ advanced AI techniques to dynamically generate personalized game narratives. The static nature of the content delivered under this patent limits the variability and replayability of the user experience.

Moreover, the existing systems and patents mentioned above often rely on predefined narrative structures, which reduce the engagement and personalization of gameplay. Maintaining narrative consistency, particularly when integrating AI-generated content in response to complex player inputs, remains a significant challenge. Disjointed or inconsistent narratives can detract from the overall user experience, and the lack of robust error-handling mechanisms to manage diverse user inputs further exacerbates this issue.

The limitations of existing text-based game systems include:
Static Narratives: Traditional text-based games rely heavily on predefined narrative paths, which limits the variability and personalization of player experiences. This static nature reduces engagement and diminishes the replayability of these games.
Accessibility Barriers: Current systems are often confined to browser-based platforms or require the installation of mobile applications, creating accessibility challenges. Users with basic mobile phones or those in regions with limited internet connectivity are often unable to access these games.
Underutilization of SMS Technology: Few existing systems fully leverage the potential of SMS/MMS for delivering interactive content. This underutilization results in missed opportunities to provide a simple, universally accessible gaming experience that does not require advanced mobile devices or constant internet access.
Narrative Consistency Challenges: Maintaining narrative coherence is a significant challenge for traditional systems, especially when integrating AI-generated content in response to complex player inputs. This often results in disjointed or inconsistent narratives that detract from the overall user experience.
Inadequate Error Handling: Existing systems lack robust error-handling mechanisms, which can disrupt gameplay when AI-generated content does not align with game context. The present invention addresses these drawbacks by implementing a dynamic, AI-driven system for generating and delivering personalized game narratives via SMS/MMS. This system enhances accessibility, maintains narrative consistency through advanced validation and error-handling mechanisms, and offers increased replayability by tailoring content to each player's interactions.

The present invention addresses these limitations by introducing a dynamic, AI-driven system for generating and delivering personalized game narratives via SMS and MMS. The system enhances accessibility by leveraging SMS technology, improves narrative consistency through advanced schema validation and error-handling mechanisms, and increases replayability by generating unique content tailored to each player's interactions.

### BACKGROUND OF THE INVENTION

The present invention relates to the field of interactive digital entertainment. Specifically, it pertains to systems and methods for dynamically generating and delivering AI-driven text-based game narratives via Short Message Service (SMS) and Multimedia Messaging Service (MMS) technologies. The invention utilizes advanced AI models to create personalized, contextually relevant game experiences accessible through widely available mobile communication platforms, eliminating the need for additional applications or internet connectivity.

### SUMMARY OF THE INVENTION

The present invention provides an innovative system and method for dynamically generating and delivering AI-driven, text-based game narratives via Short Message Service (SMS) and Multimedia Messaging Service (MMS). The invention leverages advanced AI models, specifically large language models (LLMs), to create personalized, contextually relevant game experiences accessible through widely available mobile communication platforms, without requiring additional applications or internet connectivity.

The inventive system is composed of several interconnected components:
SMS Gateway: This component facilitates the receipt and transmission of player inputs and game narratives. It acts as the primary interface between the player and the game system, ensuring real-time interaction through SMS and MMS.
Game Server: The Game Server is the central processing unit of the system. It manages the game states, processes player inputs, and generates appropriate AI prompts based on the current game context. The server also handles schema validation, ensuring that AI-generated content adheres to predefined game rules and maintains narrative coherence.
Database: The Database stores all game-related data, including player inputs, game states, and AI-generated responses. This storage ensures continuity across gaming sessions, allowing players to resume gameplay without losing progress.
Generative AI Model: The Generative AI, specifically an LLM, is responsible for generating dynamic and unique game narratives in response to player actions. The AI model produces narratives that are both engaging and contextually relevant, offering a personalized gaming experience for each player.

A key feature of the invention is its robust error handling and retry mechanism. The Game Server employs this mechanism to validate the AI-generated content against a schema, ensuring that the narratives remain consistent with the game's context and rules. If the AI's output deviates from the desired context, the system issues corrective instructions, prompting the AI to regenerate the content until it meets the required standards.

Additionally, the system includes a sophisticated player interaction tracking mechanism. It monitors the player's choices and progress, adapting the game's difficulty and narrative complexity based on the player's actions. This feature enhances player engagement by providing a tailored gaming experience that evolves with the player's decisions.

The invention also addresses several limitations of existing text-based game systems:
Static Narratives: Unlike traditional text-based games, which rely on predefined storylines, this invention dynamically generates unique content tailored to each player's interactions. This approach significantly enhances replayability and engagement.
Accessibility: The system is designed to be accessible via SMS and MMS, making it available to users with basic mobile devices or those in regions with limited internet connectivity. This broad accessibility ensures that a wide range of users can enjoy the gaming experience without the need for additional software installations or internet access.
Narrative Consistency and Error Handling: The system's robust error handling mechanisms ensure that AI-generated narratives are consistent with the game's context and rules, providing a seamless and immersive experience for the player.
Turn Management and Monetization: The system includes a player turn management component that tracks and limits the number of turns a player can take in a day, with options for players to purchase additional turns. This feature allows for balanced gameplay while also offering monetization opportunities.

This inventive system and method offer a significant advancement in the field of interactive digital entertainment by combining dynamic AI-driven content generation with the broad accessibility of SMS/MMS technology. It provides a highly engaging, personalized, and replayable gaming experience that is accessible to a wide audience.

### BRIEF DESCRIPTION OF DRAWINGS

FIG. 1 illustrates a high-level system architecture of the AI-driven text-based game narrative system, depicting the interaction between key components: the SMS Gateway, Game Server, Database, and Generative AI model. This figure provides an overview of how these components work together to deliver the game experience.

FIG. 2 shows the data flow between the system components during a typical game session. It outlines the process of receiving player inputs via SMS, generating AI-driven responses, and delivering the game narratives back to the player through SMS/MMS.

FIG. 3 provides a detailed flowchart of the error handling and validation process within the Game Server. This diagram illustrates the decision-making flow used to validate AI-generated narratives, ensuring they adhere to the predefined game rules and context.

FIG. 4 depicts a sample user interface for SMS-based game interaction. The figure highlights the process by which player inputs are captured and how system-generated responses are formatted and delivered back to the player.

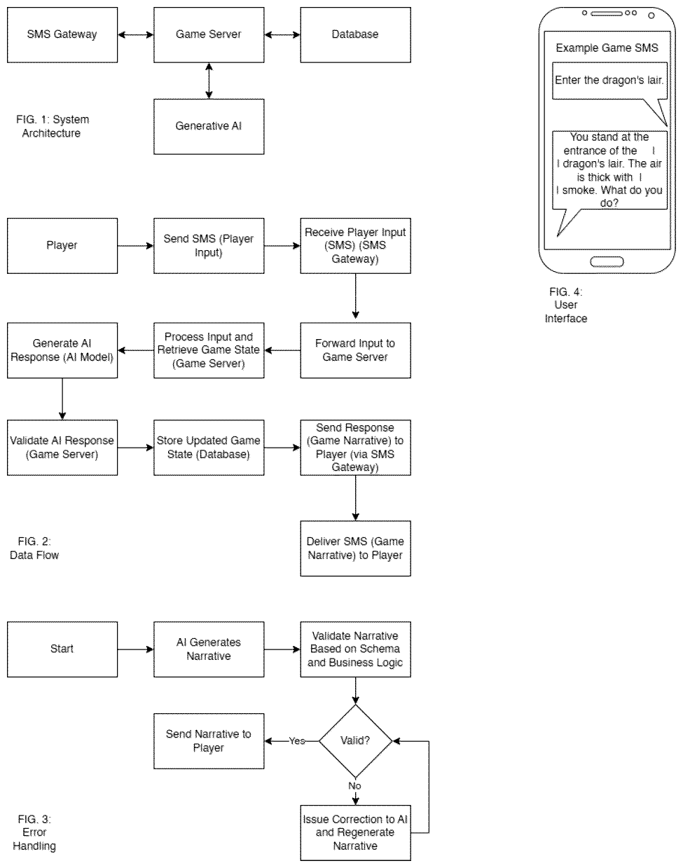

### DETAILED DESCRIPTION OF THE INVENTION

### A. Overview of the System

The invention consists of a comprehensive system designed to provide AI-driven, text-based game narratives via SMS and MMS. The system architecture includes an SMS Gateway, a Game Server, a Database, and a Generative AI model. These components work together to create a seamless and engaging gaming experience accessible through standard mobile communication platforms.

### B. Detailed Description of the System

SMS Gateway: The SMS Gateway is responsible for handling all incoming and outgoing messages between the player and the system. It receives player inputs, validates them, and forwards them to the Game Server. It also relays AI-generated responses back to the player via SMS or MMS.
Game Server: The Game Server is the core component of the system. It processes player inputs, manages game states, and generates prompts for the Generative AI model. The server is equipped with schema validation mechanisms to ensure that AI-generated content aligns with the game's context and rules. It also includes error handling processes that correct any deviations in the AI's output.
Database: The Database stores all game-related data, including player inputs, game states, and AI-generated responses. It provides a persistent storage solution that allows players to continue their game sessions without losing progress. The Database also tracks player interactions and progress, enabling the system to adapt the game's difficulty and narrative complexity based on the player's actions.
Generative AI Model: The Generative AI model, specifically a large language model (LLM), is responsible for generating dynamic and contextually relevant game narratives. The AI processes the prompts generated by the Game Server and produces narratives that are personalized to each player's inputs. The AI model is also capable of generating alternative responses if the initial output does not meet the required standards.

### C. Detailed Description of Methods of Use

Initiating a Game Session: A player initiates a game session by sending a message to the system's designated SMS number. The SMS Gateway captures the player's input, validates it, and forwards it to the Game Server.
Processing Player Input: The Game Server processes the player's input by retrieving the current game state from the Database and generating a prompt for the Generative AI model. The AI model generates a narrative response based on the player's input and the game's context.
Validating AI-Generated Content: The Game Server validates the AI-generated narrative against a predefined schema to ensure it aligns with the game's rules and context. If the output deviates from the intended context, the system issues corrective instructions to the AI, prompting it to regenerate the content.
Delivering the Game Narrative: Once the AI-generated content is validated, the Game Server relays the narrative back to the player via the SMS Gateway. The player can then respond with their next action, continuing the interactive gameplay.
Tracking Player Progress: The Database continuously tracks the player's actions and progress, allowing the system to adapt the game's difficulty and narrative complexity. The system also enforces daily turn limits and provides monetization options for purchasing additional turns.

### D. Examples of Use Cases

Fantasy Adventure: A player texts ‘Enter the dragon's lair.’ The system retrieves the game state, processes the input, and generates a narrative where the player encounters a dragon. The narrative includes options for the player to choose their next action, such as attacking the dragon or negotiating with it. Based on the player's choice, the AI generates further narratives that develop the story.
Detective Mystery: In a detective game, the player texts ‘Search the crime scene for clues.’ The system processes the input, generating a narrative where the player discovers a hidden clue. The system then offers options for further investigation, such as interviewing witnesses or analyzing the clue, each of which leads to different narrative branches.
Sci-Fi Exploration: In a science fiction exploration game, the player texts ‘Scan the alien planet's surface.’ The system processes the input, generates a narrative where the player uncovers a mysterious artifact, and provides options for how to proceed with the discovery, such as studying the artifact or reporting it to command, with each choice influencing the subsequent story.

1. A method for providing text-based games via SMS, comprising: capturing player inputs through an SMS Gateway, including receiving and parsing said inputs; processing said inputs by analyzing them with predefined algorithms to generate prompts for an AI model based on stored game states and incoming player inputs; utilizing a Generative AI model to produce game narratives in response to player inputs; validating AI-generated narratives through schema validation and rule-based checks to ensure consistency with predefined game rules and context; and delivering the validated game narratives back to the player via the SMS Gateway.

2. The method of claim 1, wherein each unique gaming narrative provides a personalized gaming experience by dynamically generating content in real-time based on the player's previous choices and input patterns.

3. The method of claim 1, further comprising transmitting graphical game components via MMS, including but not limited to image-based clues, character illustrations, or game artifacts, wherein said graphical components are dynamically integrated with the text-based narrative to enhance gameplay and provide essential narrative elements.

4. A system architecture for providing an AI-driven text-based game, comprising: an SMS Gateway for receiving player inputs and delivering game narratives to player mobile devices; a Game Server, including a rule engine for enforcing game rules, which interacts with the AI model and player inputs to generate prompts, evaluates AI-generated content, and ensures consistency in the game narrative; a relational Database for storing and retrieving game states, player inputs, and AI-generated content, ensuring continuity across gaming sessions; and a Generative AI model for creating dynamic and personalized game narratives in response to player inputs and game context.
